(19) United States
(12) Patent Application Publication
(10) Pub. No.: US 2018/0032634 A1
(43) Pub. Date: Feb. 1, 2018

(54) SYSTEM AND METHODS FOR RETRIEVING AND DISPLAYING DATA UTILIZING A CONTENT AUTHORING TOOLKIT (CAT)

(71) Applicant: ALQIMI Analytics & Intelligence, LLC, Rockville, MD (US)

(72) Inventors: Walter GREENBERG, Rockville, MD (US); Kevin M. DONOHUE, Rockville, MD (US)

(21) Appl. No.: 15/224,468

(22) Filed: Jul. 29, 2016

(51) Int. Cl. G06F 17/30

(52) U.S. Cl. CPC G06F 17/30941; G06F 17/30864; G06F 17/30938

(57) ABSTRACT

Some embodiments are directed to a method for displaying an output data on a user terminal, the method including receiving an input data through a web interface on the user terminal and transmitting the input data to a portal server through an input portlet. The method also includes generating an XML configuration file comprising at least one of document data, a markup and a script code. The method further includes storing and processing the XML configuration file by the portal server. The method further includes retrieving the output data from a data source based on at least a parameter specified in the XML configuration file. The method further includes displaying the output data on the web interface based on at least one option specified in the XML configuration file.

### BACKGROUND

The disclosed subject matter relates to data retrieval and display, and more specifically to a system and methods for displaying data retrieved from remote data sources on a web portal. In particular, the disclosed subject matter relates to a portal with one or more portlets that are designed to display information from diverse data sources. Retrieved data is typically presented in web pages or web-based graphical user interfaces.

The web portal is designed to publish information for access by users. Generally, each information source gets its dedicated area on the page for displaying information, which is known as a portlet. Portlets are pluggable user interface software components that are managed and displayed in a web portal. Further, portlets can be considered as building blocks for creating complex web portals with sophisticated features.

Services relating to data retrieval can be implemented as software components that provide content and/or functionality to remote web applications through the Internet. Remote applications can submit requests for information to web services and receive content in return. Similarly, applications can pass queries to web services by deploying configuration files that contain information regarding the data source, various search filters and display options. A result is returned from the web service to the application based on the queries. Web service content can be passed to a client of the application where it can be displayed, processed, or otherwise utilized.

### SUMMARY

Various applications for retrieving data from data sources and displaying the retrieved data on user or client terminals are well known. However, each application can retrieve only a specific type of data or data from a specific data source and can display the data into a pre-build page on a web portal. Further, such applications also need to be present locally on a user or a client terminal.

Some related arts access data from multiple data sources and store the retrieved data in a data warehouse. The data stored on the data warehouse is then displayed on the client or user terminals. However, the data stored in the data warehouse may be in a raw format and further formatting of the data is required before the data can be displayed. Further, data retrieval processes are generally implemented by an application server. An application server can be any software framework that facilitates the creation of web applications and a server environment to run them. It behaves as a virtual machine that runs applications and handles connections to data sources on one end and connections to the client terminal or user terminal through a web client or web portal on the other end. However, using only an application server or a cluster of application servers can limit the dynamic delivery of information. Further, additional processing functions need to be performed by an end-user or client to obtain information in a customized format. Complex client applications are also required to process and display the data retrieved. Moreover, a level of expertise in programming and information technology is required to utilize such complex client applications. Therefore, such data retrieval and display processes may be difficult for a non-technical end-user to implement.

Some related arts use applications present on the client terminals to format and display retrieved data. However, such applications format the retrieved data based on predefined algorithms without providing any option to a user to control the presentation of the retrieved data.

It may therefore be beneficial to provide systems and methods to retrieve data from one or more data sources and display the data in accordance with user-defined display options and data retrieval filters. Specifically, it may be beneficial to generate one or more portlets to facilitate retrieval of data in a legible format. One or more portlets are generated by a portal server to facilitate a single point of access to data from multiple data sources for end-users or clients.

It may also be beneficial to provide systems and methods to retrieve data from multiple data sources and store the retrieved data in a database in a predefined format. The stored data is displayed in accordance with user-defined display options and data retrieval filters without the need of any programming to format the retrieved data.

It may also be beneficial to provide a specification-compliant portlet that provides a web based configuration interface that facilitates the creation and storage of configuration files. The configuration files include document data, a markup, and a script code for manipulating data and markup. Using a web interface designed for a non-technical end-user, a series of data-presentation options may be selected or configured and saved to an XML (Extensible Markup Language) configuration file. A portal server, with the portlet installed, may be used to present a view of the data as per the configuration options stored in the XML configuration file. Examples of available configuration options include data retrieval filters, data export formats (XML format, Comma Separated Values or CSV format), and various levels of summary and detail.

It may also be beneficial to provide systems and methods that enable a user to create one or more configuration files which dictate certain display options. For example, each configuration file corresponds to a specific user's desired data feeds and/or display options

It may also be beneficial to provide systems and methods that assist an end-user in generating meaningful, optimal queries without the need of detailed knowledge of programming and information technology. For example, a graphical user interface can be configured to assist an end-user in creating a query and removing unnecessary data retrievals so that the query is optimized to be executed in a processing environment.

Some embodiments are directed to a method for displaying output data on a user terminal. The method includes receiving input data through a web interface on the user terminal, wherein the web interface interacts with an input portlet on a portal server. The method further includes transmitting the input data to a portal server through the input portlet and generating an XML configuration file comprising at least one of document data, a markup and a script code. The method further includes storing and processing the XML configuration file on the portal server. The method is further directed to retrieving the output data from a data source based on at least a parameter specified in the XML configuration file, and exchanging the output data between the data source and the user terminal via a non-transitory computer readable medium. Further, the exchange of the output data is based on at least the parameter specified in the XML configuration file. The method also includes displaying the output data on the web interface based on at least one option specified in the XML configuration file.

Some other methods are directed to a method of displaying output data on a user terminal. The method includes receiving input data through a web interface on the user terminal, wherein the web interface is communicably coupled to a portal server. The method also includes generating an XML configuration file by the portal server, wherein the XML configuration file comprises document data, a markup and a script code. The method further includes embedding the input data in the XML configuration file and retrieving the output data from a data source in accordance with at least one parameter specified in the XML configuration file. The method is further directed to generating one or more output portlets on the web interface by the portal server. The method also includes displaying the output data based on at least one option specified in the XML configuration file through the one or more output portlets.

Yet other embodiments are directed to a system for displaying an output data on a user terminal, the system including a web interface disposed on the user terminal, wherein the web interface is configured to receive an input data through the user terminal. Further, the input data corresponds to a data source. The system further includes a processor that is configured to generate an XML configuration file based on the input data, the XML configuration file including at least one of document data, a markup and a script code. The system also includes a portal server communicably coupled to the user terminal and the data source, the portal server configured access the XML configuration file, and retrieve the output data from the data source in accordance with at least one parameter specified in the XML configuration file. The portal server is also configured to generate one or more output portlets on the web interface. The portal server is further configured to display the output data on the one or more output portlets.

### BRIEF DESCRIPTION OF DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIGS. 1A, 1B and 1C illustrate various exemplary systems for retrieving and displaying data in accordance with the disclosed subject matter.

FIG. 2 illustrate a schematic of a Content Authoring Toolkit (CAT) in accordance with the disclosed subject matter.

FIGS. 3A and 3B are schematics of a user interface shown on a portal page in accordance with the disclosed subject matter.

FIG. 4 is a flowchart of an exemplary method of displaying data in accordance with the disclosed subject matter.

FIG. 5 is a flowchart of an exemplary method of displaying data in accordance with the disclosed subject matter.

FIG. 6 is a computer system that can be used to implement various exemplary embodiments of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

I. Server Environment

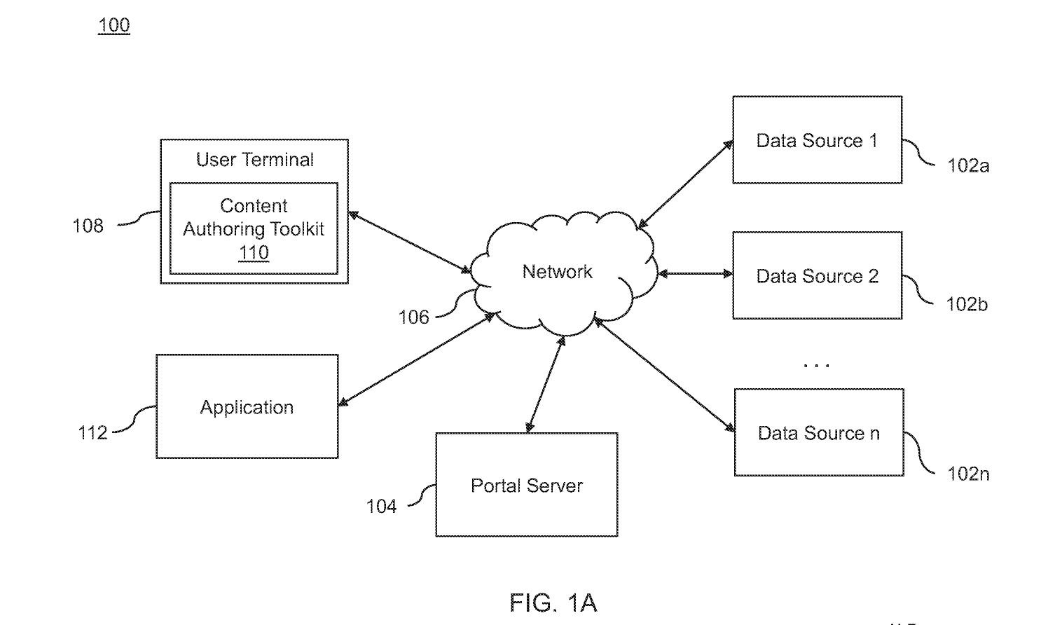

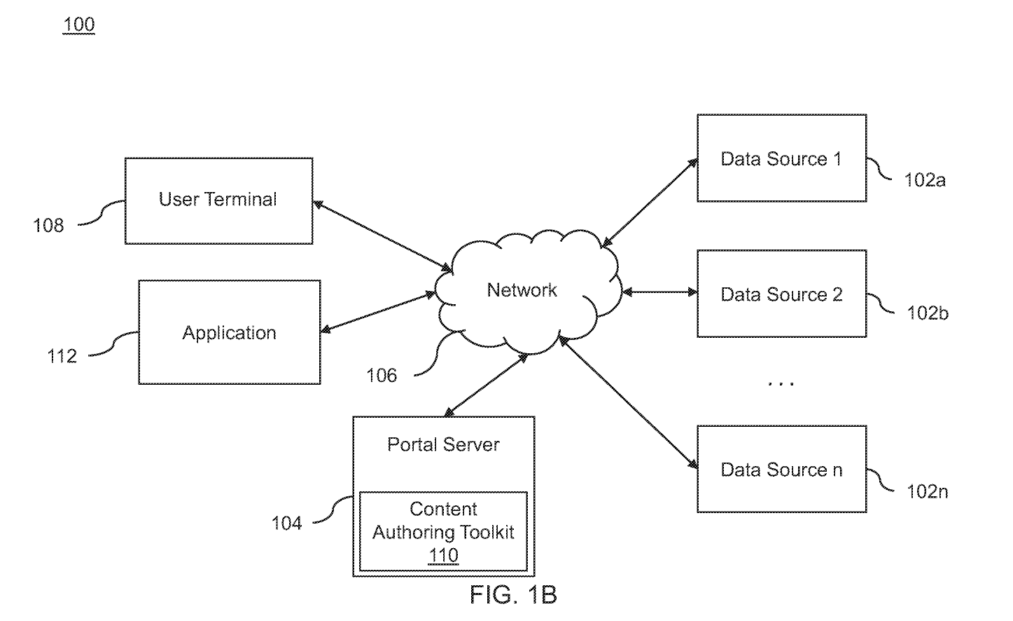

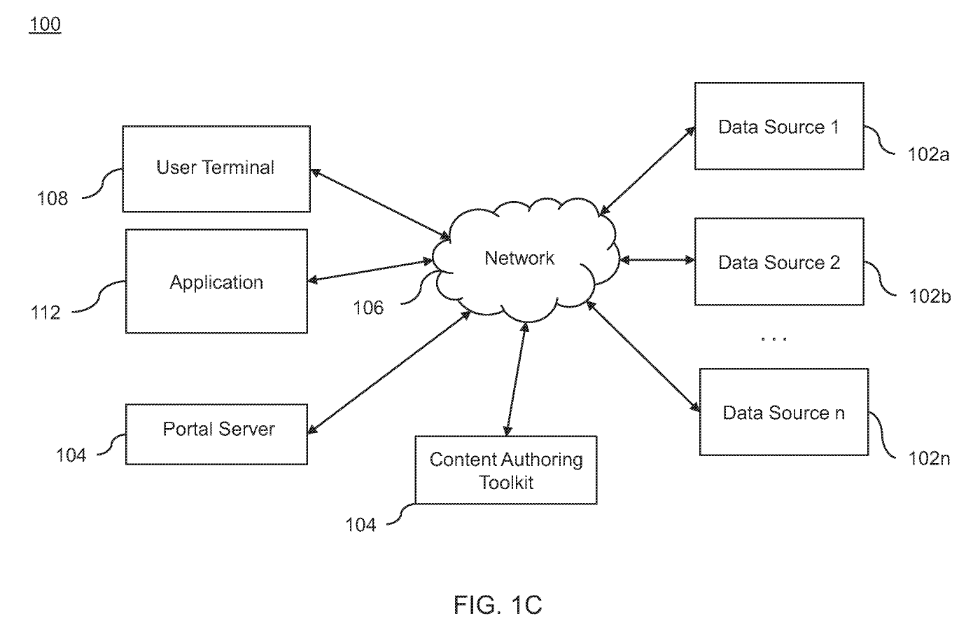

FIG. 1A is an illustration of a system 100 in accordance with the disclosed subject matter. The system 100 is configured to retrieve and display data. Specifically, the system 100 facilitates exchange of data between a user terminal 108 and one or more data sources 102 through one or more portlets installed on a portal server 104. In some instances, the portal server 104 may be positioned in series with the user terminal 108, or may even be configured as a part of the user terminal 108 itself (such as an app, an Operating System routine, or the like). The data to be exchanged is retrieved in accordance with an Extensible Markup Language (XML) configuration file that may contain various types of information. This information can include, but is not limited to, document data, a markup, and a script code from manipulating data and markup. The XML file can also include keywords, connection information, data retrieval filters and so forth.

The data sources 102a to 102n (hereinafter collectively referred to as “the data sources 102”) are intended to be any type of data source including social media networks, search engines, portals, remote servers, network storage units, etc. Embodiments are also intended to include or otherwise cover any other type of data source. The data sources 102 are merely provided for exemplary purposes, and the various inventive aspects are intended to be applied to any type of data source on a network 106 connected to the portal server 104, an application 112 and the user terminal 108.

The network 106 may include a data network such as, but not restricted to, the Internet, local area network (LAN), wide area network (WAN), metropolitan area network (MAN), etc. In certain embodiments, the communication network 106 can include a wireless network, such as, but not restricted to, a cellular network and may employ various technologies including enhanced data rates for global evolution (EDGE), general packet radio service (GPRS), global system for mobile communications (GSM),

Internet protocol multimedia subsystem (IMS), universal mobile telecommunications system (UMTS) etc. In some embodiments, the communication network 106 may include or otherwise cover networks or subnetworks, each of which may include, for example, a wired or wireless data pathway. The communication network 106 may include a circuit-switched voice network, a packet-switched data network, or any other network capable for carrying electronic communications. For example, the network 106 may include networks based on the Internet protocol (IP) or asynchronous transfer mode (ATM), and may support voice usage, for example, VoIP, Voice-over-ATM, or other comparable protocols used for voice data communications. In one implementation, the network 106 includes a cellular telephone network configured to enable exchange of text or SMS messages.

Examples of the network 106 may further include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth. Embodiments are intended to include or otherwise cover any type of network, including known, related art, and/or later developed technologies to connect the data sources 102, the portal server 104 and the user terminal 108 with each other.

The user terminal 108 is intended to include any electronic device, such as desktop computers, portable computers, smartphones, tablet computers, wearable devices, and the like. The user terminal 108 may also include a display unit (not shown) for displaying any data. The display unit can include, but not limited to, a Cathode Ray Tube (CRT) display, a Liquid Crystal Display (LCD), a Light Emitting Diode (LED) display, and the like. Embodiments are intended to include or otherwise cover any type of display, including known, related art, and/or later developed technologies.

A Content Authoring Toolkit (CAT) 110 is a specification-compliant portlet that provides a web interface to facilitate the creation and storage of configuration files containing document data, markup, and script code for manipulating data and markup. The CAT 110 offers an easily accessible method by which non-technical end-users may make data, markup, and script code available for use on the portal server 104. The configuration files created via the CAT 110 are stored on the portal server 104 in an XML format and are processed by the portal server 104 for retrieving and displaying data on the user terminal 108 when made available via portal configuration. More particularly, the CAT 110 is primarily responsible for generating the XML configuration files that dictate portlet sources, display options, etc. In some embodiments, the CAT 110 may be part of the user terminal 108, as seen in FIG. 1A. In some other embodiments, the CAT 110 may be part of the portal server 104 (as shown in FIG. 1B) or may be placed next to the portal server 104 (as shown in FIG. 1C). In some embodiments, the CAT 110 may be provided by the application 112.

The application 112 can contain a non-transitory computer readable medium that can be configured by a computer processor to perform various operations related to the portal server 104. The non-transitory computer readable medium can contain a set of instructions written in various programming languages, such as, C, C++, Java, Python, and so forth.

In some embodiments, the application 112 can be implemented as a servlet. The servlet is a java program that extends the capability of a server. Specifically, the servlet implements applications hosted on the server by receiving a request and generating a response based on the request. Further, the servlet can define Java objects that represent servlet requests and their responses, the configuration parameters of the servlet and an execution environment. Servlets may be packaged in a Web application ARchive file (WAR file) as a web application.

In some embodiments, the application 112 includes pages, portlets, communication channels between the portlets, and so forth. The application 112 can act as an interface between the portal server 104 and the data sources 102.

The application 112 is executed by the associated computer processor and carries out various functionalities of a web interface. Though the web interface is designed for a non-technical end-user, a series of data-presentation options may be selected (configured) and saved into an XML (Extensible Markup Language) configuration file. Therefore, the end-user can enter display preferences through the web interface without any programming. In an exemplary embodiment, the data containing the user preferences can be entered through the web interface that interacts with the portlet. The XML configuration file can be created or modified based on the entered data. In an alternate embodiment, the XML configuration file can be manually configured. For example, the XML configuration file may be configured in a word processing application.

Further, the XML configuration file can be stored and processed by the portal server 104. The portal server 104 can retrieve data from the data sources 102 based on the parameters specified in the entered data. The data can be displayed on the user terminal 108 based on the options specified by the user in the XML configuration file. In some embodiments, the XML configuration file may include artistic guidelines, such as displaying a three-day weather forecast in the top-left corner of a portal page, and news in the bottom-right corner the portal page. The XML file may also be arbitrarily specific, such as weather in Seattle being displayed in the top left of the portal page, while arrest reports from anyone in Miami named “Edward” being displayed in the bottom right corner of the portal page.

In alternative embodiments, a processor (not shown) associated with the user terminal 108 may generate the XML configuration file and store it on a memory (not shown) associated with the user terminal 108. Further, the portal server 104 may be communicably coupled to the user terminal 108 in order to access the configuration options stored in the XML configuration file and to the application 112 in order to receive a set of data stored in a predefined format. In other embodiments, the processor, that generates the XML configuration file, may be associated with the portal server 104.

A portal associated with the portal server 104 can be a web portal or an enterprise portal and is configured to aggregate data from different sources and display the aggregated data. In an embodiment, the portal is a web page or web interface that brings information together from diverse sources. Therefore, the web interface, as described above, may be implemented in the form of a portal. In some other embodiments, the portal is configured to receive an end-user request from the user terminal 108. The end-user request further corresponds to a specific data source. Each piece of information from the specific source gets a dedicated display or presentation area on the portal as defined by an end-user or web designer. The dedicated display or presentation area can be handled or managed by one or more portlets. Portlets are applications used by a data portal website to receive requests from a client terminal or a user terminal and return information.

II. Portals and the Content Authoring Toolkit

A web portal is a specially designed web site or web interface that brings information together from diverse sources in a uniform way. Usually, each information source gets its dedicated area on the page for displaying information (a portlet). Further, an end-user can configure which ones to display. Variants of portals include mashups and intranet “dashboards” for executives and managers. The extent to which content is displayed may depend on the intended end-user and the intended purpose, as well as the diversity of the content. Very often design emphasis is on a certain “metaphor” for configuring and customizing the presentation of the content and the chosen implementation framework and/or code libraries. In addition, the role of the end-user in an organization may determine which content can be added to the portal or deleted from the portal configuration.

A portal may use a search engine Application Program Interface (API) to permit end-users to search intranet content as opposed to extranet content by restricting which domains may be searched. Apart from such common search engine feature, web portals may offer other services such as e-mail, news, stock quotes, information from databases and even entertainment content. Portals provide a way for enterprises and organizations to provide a consistent look and feel with access control and procedures for multiple applications and databases, which otherwise would have been different web entities at various Uniform Resource Locators (URL). The features available may be restricted by whether access is by an authorized and authenticated end-user (employee member) or an anonymous site visitor.

Portal servers provide a central platform for accessing web content and resources (data, docs, apps, integrations, alerts, etc.). A core feature of a portal is to provide a central URL that permits an end-user to have a custom web experience based upon the end-users' login identity. This functionality is termed role-based content delivery, or RBCD, and is a main focus for portals.

Websites based on Role-based Content Delivery (RBCD) allow an enterprise to develop a central web platform. Enterprises can then advertise a single website, and thereby increase the usage of the entire enterprise's resources as the central portal can integrate or guide end-users to other resources. RBCD has allowed administrators to build portal pages for different end-user types to customize the end-user experience based on an end-user's “formal identity,” such as a salesperson, engineer or manager.

Given that portal pages can include both applications (portlets and widgets) and web content, many portals have begun supporting integration to an external web content management system (WCMS) allowing content to be created or managed in a WCMS that appears in a portal page. In some embodiments, the portal page is configured to receive an end-user request from an end-user. This two-step process of adding content prompted some other portals to create an embedded WCMS.

Portals additionally have begun to focus on end-users, allowing such end-users to interact with the system. End-users are often allowed to create their own pages or sites, to add collaboration apps to those pages and to define end-user access to those pages. Many portals also enable power end-users to have added features, such as web forms, workflows, dynamic lists and polls.

This focus on enabling the end-user, combined with RBCD, allows a central site to enable both the formal organizational structure as well as the informal organizational structure (i.e., social collaboration) and is a major difference between portals and many WCMS systems.

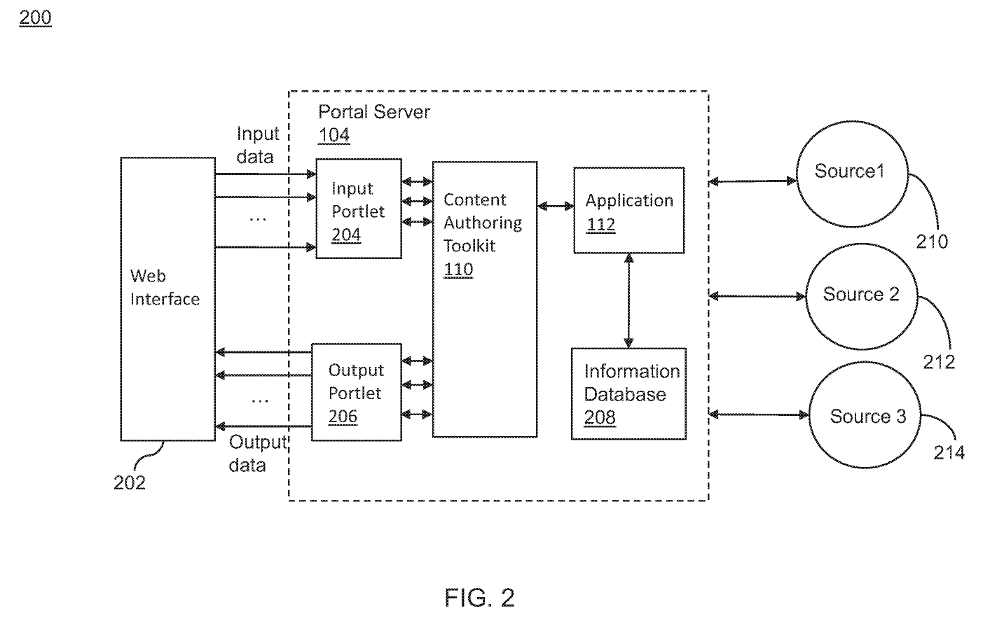

FIG. 2 illustrates a system 200 including the Content Authoring Toolkit (CAT) 110 installed on the portal server 104, in conjunction with a web interface 202, the data source 210, the data source 212 and/or the data source 214. The web interface 202 interacts with an input portlet 204 and an output portlet 206. The web interface 202 is installed on a user terminal (not shown) to receive input data from an end-user in order to create or modify an XML configuration file. The input data corresponds to the end-user's desired data feeds and/or display options. Alternatively, the input data corresponds to different topics of interest, such as weather forecasts around a country, political news, etc. The XML configuration files set the display options that can dictate display of output data on the web interface 202 through the output portlets 206.

The web interface 202 is configured to receive the input data. The input data is based on the data to be retrieved. The input data may include, but are not limited to, user preferences, data retrieval filters and/or display options. The XML configuration file is generated or modified based on the input data. The XML configuration file includes at least one of document data, a markup, and a script code.

Document data may include, but not limited to, data retrieval filters. The data retrieval filters include one or more identities indicative of a data sources, for example, the data source 210, the data source 212 and/or the data source 214. The markup is a sequence of characters or other symbols that are entered by the end-user through the web interface 202. Alternatively, the markup may be pre-configured within the XML configuration file. The markup describes display options information of the output data. Display options include, but are not limited to, at least one of a tabular layout, a chart layout, a news layout, a form layout, and a bullet layout. The display options can also include a font, color, location and other parameters of the displayed data.

The script code is a small set of expressions and statements which can be used by the portal server 104 to retrieve the output data from data sources 210, 212 and/or 214. The script code can be used for executing the end-user request received at the web interface 202. The script code may include a function, a procedure, a method, or a block of code that may be embedded with the XML configuration file. The script code implements various functions, for example, retrieving information stored in various data sources of the system 200, performing computations, or interacting with other systems.

The XML configuration file can also include connection information, data retrieval filters and so forth. Connection information includes, but not limited to, IP addresses, subnet masks, domain name server addresses, host name and suffix, execution parameters, and system information pertaining to the user terminal 108 and/or the portal server 104.

The input portlet 204 is installed on the portal server 104. The web interface 202 interacts with the input portlet 204 to transmit the input data to the portal server 104. The input portlet 204 is configured to transmit the input data received through the web interface 202 to the portal server 104. The input portlet 204 is communicably coupled with the Content Authoring Toolkit (CAT) 110.

The web interface 202 is communicably coupled to the output portlet 206. The output portlet 206 is installed and placed on the portal server 104. The output portlet 206 is configured to display the output data on the web interface 202 based on the document data and markup specified in the XML configuration file. The output data is retrieved from the data sources 210, 212 and/or 214, in accordance with the document data, markup and script code specified in the XML configuration file.

The CAT 110 provides a web based configuration interface to facilitate the creation and storage of configuration files containing the document data, markup, and script code for manipulating data and markup. The CAT 110 offers an easily accessible method by which end-users may make data, markup, and script code available for use on the portal server 104. The configuration files created via the CAT 110 are stored on the portal server 104 in an XML format and are processed by the portal server 104 for displaying the output data on the web interface 202. More particularly, the CAT 110 is primarily responsible for generating the XML configuration files that dictate portlet sources, display options, etc.

In some other embodiments, the CAT 110 may facilitate modification of a previously stored XML configuration file. The web interface 202 is configured to receive modification data to modify the previously stored XML configuration file. The modification data may include, but is not restricted to, changes in parameters an end-user may want to implement in the previously stored XML configuration file.

The CAT 110 can enable the end-user to formulate queries in accordance with complex query syntax requirements. Specifically, the CAT 110 can cause a processor (not shown) associated with the portal server 104 to assist the end-user to generate executable optimal queries without requiring detailed knowledge of coding. Additionally, the CAT 110 can generate code or queries that can run more efficiently than manually formulated code or queries. In some embodiments, the CAT 110 may assist the end-user in the creation and modification of the XML configuration file. Further, the CAT 110 may also guide the end-user to remove unnecessary data retrieval filters from necessary data retrieval filters. Unnecessary data retrieval filters may include duplicate or overlapping filters, while necessary data retrieval filters may include data source identifiers, necessary time filters, keywords, location filters, and so forth. In some other embodiments, the CAT 110 is configured to guide the end-user to create queries that are familiar and optimized to the processor associated with the portal server 104.

The portal server 104 includes the application 112 which further includes a non-transitory computer readable medium. The application 112 is configured to access data from the data sources 210, 212 and/or 214. The application 112 may be a set of instructions executable by the portal server 104 to carry out various operations including, but not limited to, accessing and retrieving data, storing data, generating portlets and displaying data through the portlets. In some embodiments, the non-transitory computer readable medium can be configured by the portal server 104 to carry out various operations. Further, configuring the non-transitory computer readable medium may include executing the instructions stored therein.

The application 112 is configured to retrieve the output data from multiple data sources 210, 212 and/or 214 based on at least a parameter specified in the XML configuration file. The parameter may be, but not restricted to one or more identities indicative of the data sources 210, 212 and/or 214. The application 112 is configured to transform the output data in accordance with a predefined format. The predefined format corresponds to the data being organized in multiple tables with a key identifying a row and/or column in each table in the data. The keys are used to define logical connections between the rows and columns of one table and the rows and columns of another table. The transformed data is stored in an information database 208. The information database 208 is configured to store frequently used data so that it is made available upon receiving a user query from the user terminal 108. In some embodiments, the data may be retrieved in real time as per the input data received at the input portlet 204 through the web interface 202. The application 112 is configured to exchange the output data between the data sources 210, 212 and/or 214, and the user terminal 108 (shown in FIG. 1A). The exchange of the output data is based on at least the parameter specified in the XML configuration file.

The information database 208 may be a relational database and/or an object-relational database. The information database 208 organizes data into one or more tables of columns and rows with a key identifying a row and/or column in each table. The keys for each row and/or column are used to define logical connections (called relationships) among the tables. Based on the end-user requests, the data residing in the tables are manipulated such that the data is presented at the user terminal 108 in a legible format. The data stored in multiple tables on the information database 208 is retrieved from any or a combination of the data sources 210, 212 and/or 214 by the application 112. In some embodiments, the data may be retrieved in real time as per the user query received at the portal server 104. In some other embodiments, the data may be retrieved and stored in the information database 208 before a user query is received at the portal server 104.

In an alternate embodiment, the portal server 104 can transform the data retrieved (i.e., the output data) from the data source 210, the data source 212 and/or the data source 214 in accordance with the predefined format and populate the tables of the information database 208 with the data retrieved from the data sources 210, 212 and/or 214. The portal server 104 can implement various algorithms to convert or transform the retrieved or output data including, but not limited to, statistical methods, probabilistic methods, and so forth. In case, any data does not include an entry corresponding to any of the tables, the tables are left blank. Therefore, the information database 208 may allow standardization of data from different data sources, and enable quick display of the stored data in accordance with the predefined format and the display options.

The portal server 104 extracts the output data stored in the information database 208 through the application 112 based on the XML configuration file. The retrieved output data is further displayed on the web interface 202 through the output portlet 206 in accordance with the markup specified in the XML configuration file. The web interface 202 may include a user interface for receiving user inputs and displaying the output data. The user interface will be described hereinafter in greater detail.

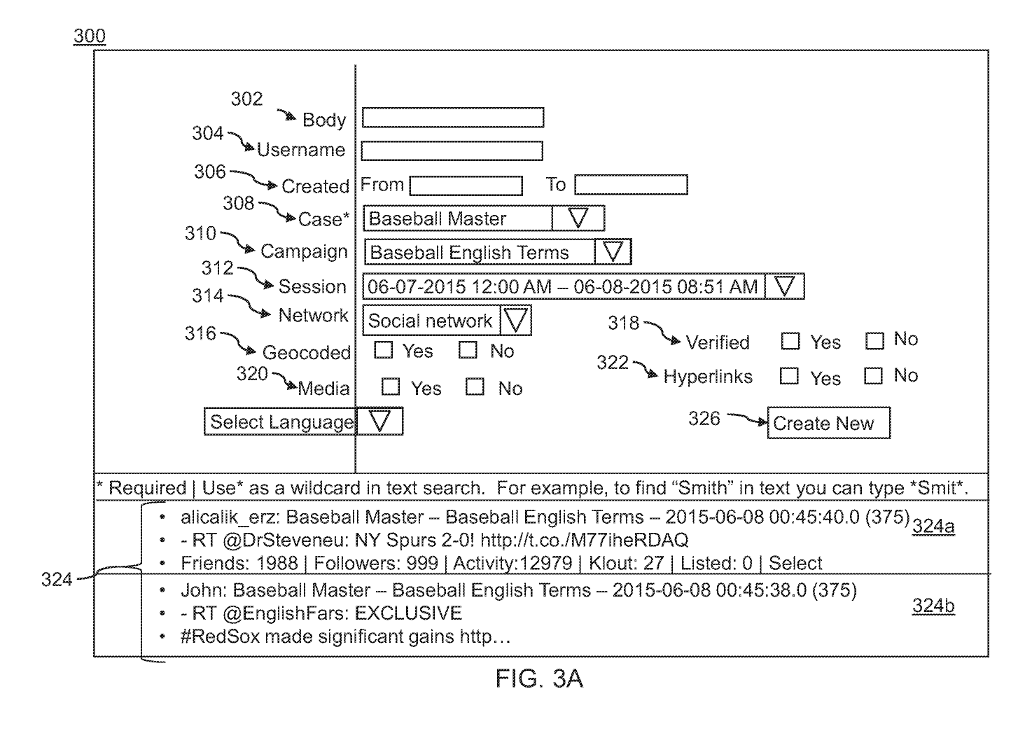

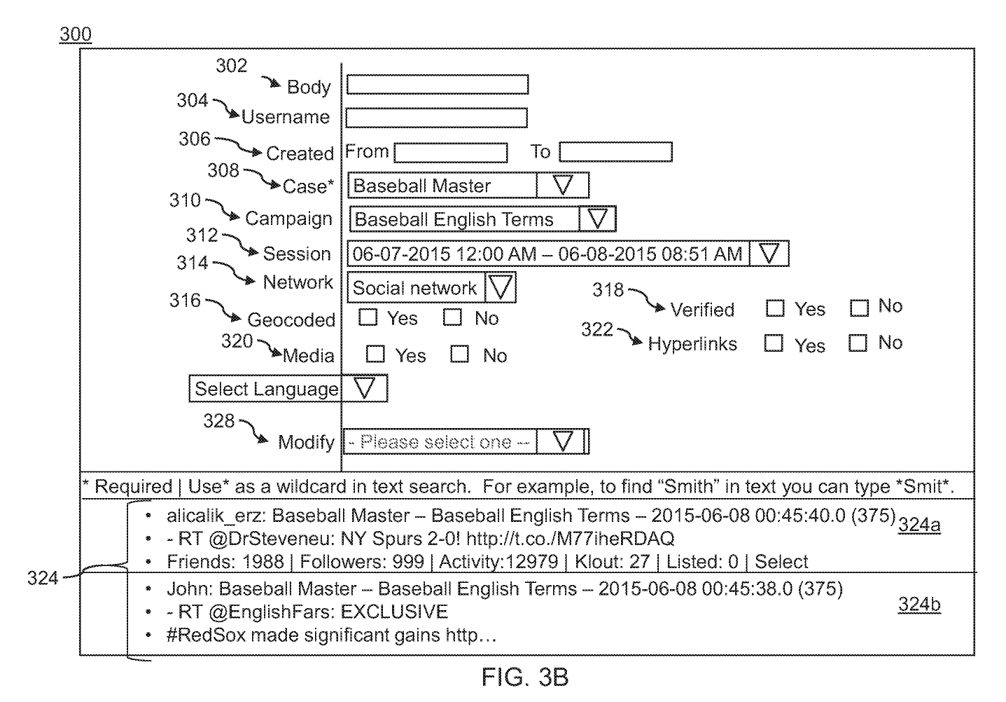

FIGS. 3A and 3B illustrate various embodiments of a user interface 300 presented on the user terminal 108. The user interface 300 may be part of the web interface 202 (shown in FIG. 2) or portal that communicates with the portal server 104. As illustrated in FIG. 3A, the user interface 300 includes fields for the input data and the output data. The fields include, but are not limited to, a body field 302, a username field 304, a query creation dates field 306, a query title or case field 308, a language of retrieved data field 310, date/time stamp details field 312, a data source field 314, location filters field 316, authenticate filters field 318, a selection field 320 for the retrieval of images, videos and/or audio, a field 322 for hyperlink filters, a create new button 326 and a user guide button 330. Results field 324 displays the output data according to choices made in the aforementioned fields. Each of the fields 302 to 322 and the results field 324 may correspond to one or more portlets generated by the portal server 104. In particular, the fields 302 to 322 may correspond to one or more input portlets, while the results field 324 can include one or more output portlets. The create new button 326 is configured to generate a new XML configuration file based on the input data. The user interface 300 is configured to enable the end-user to formulate queries and generate corresponding XML configuration files in accordance with complex query syntax requirements. Subsequently, the field 303 to 322 may assist the end-user to provide suitable inputs and generate executable optimal queries without requiring detailed knowledge of coding. Further, the user guide button 330 is configured to allow the end-user to access a manual or a guide to create and/or modify meaningful, optimal queries. In some embodiments, the end-user is provided with various XML configuration file options for different queries. The various XML configuration file options can be further displayed on the user interface 300 sequentially so that the end-user can easily create a query. The manual or guide can be, but is not restricted to, a document, on-screen tips or hints, pop-up messages, exemplary entries, or a notification. Further, the manual or the guide can include, but is not restricted to, steps to create a query, steps to modify a query, and details of data retrieval filters and display options. Further, the results field 324 is associated with a first output portlet 324a and a second output portlet 324b. The first and second output portlets 324a, 324b may be generated by the portal server 104.

Choices made on the user interface 300 form the input data and is embedded into an Extensible Markup language (XML) configuration file stored on the portal server 104.

In an alternate embodiment, as shown in FIG. 3B, the user interface 300 includes fields for receiving modification data and displaying the output data. The fields include, but are not limited to, a body field 302, a username field 304, a query creation dates field 306, a query title or case field 308, a language of retrieved data field 310, date/time stamp details field 312, a data source field 314, location filters field 316, authenticate filters field 318, a selection field 320 for the retrieval of images, videos and/or audio, a field 322 for hyperlink filters, a modify field 328 and a user guide 330. In some embodiments, in case one or more inputs entered by the end-user through one or more fields 302 to 322 on the user interface 300 is incorrect or in a wrong format, the CAT 110 in cooperation with the portal server 104 may return an error message and assist the end-user to correct the one or more inputs. The modification data is entered by the end-user in order to modify a previously stored XML configuration file. The modification data, corresponding to the previously stored XML configuration file, is received through the web interface 300 via fields 302 to 320. The modify field 328 is configured to allow the end-user to select the previously stored XML configuration file for modification. An example of the information stored in the XML configuration file is shown below:

```
<QuerySettings>
    <DatabaseVendor>PostgreSQL</DatabaseVendor>
    <Connection>
      <ConnectionID>2</ConnectionID>
    </Connection>
    <QueryString>SELECT verifiedimg, verifiedyn, username,
displayname, authorkloutscore, useractivitycount, friends,
followers, listedcount, favoritescount, retweetcount,
generator, verified, profileimgurl, network, created, createdyear,
createdmonth, createdday, body, isre, origobjsrcid, objectsrcunid,
origauthor, sourceid, hashtags,
languages, expandedurls, verb, usermentionsnames, usermentionsids,
mediaurls, Ion, lat, headline,
tagline, createdby, objectcreateddate, geocoordinates,
linktoobject, resultid, Geocoded, globe, resultid, id, userbiolocation,
mediatype, usermentionsscreennames, actorid, verified, userbiolocation,
sentiment_tag, sentiment_score, user_sentiment_votes,
user_sentiment_average, user_sentiment_mode,
user_sentiment_median, mediayn, tsv_body
</QueryString>
</QuerySettings>
-<DisplaySettings>
<CommonTitleBar>true</CommonTitleBar>
<DipHeader>true</DipHeader>
. </DisplaySettings>
```

The above is a snippet from an exemplary XML configuration file used in accordance with the disclosed subject matter. Each XML configuration file uses a single query extracted from inputs received through the user interface 300 to retrieve data from multiple tables within the information database 208.

The XML configuration file is used for the processing, definition and presentation of the input data and the output data on the user interface 300. Through the XML configuration file, code is specified for formatting various layouts and styles pertaining to presentation of data. The XML configuration file, as seen in the sample code above, includes the end-user request that further includes communication information, display options and data retrieval filters. The XML configuration file provides connection information to enable a connection between the user terminal 108 and the information database 208 (in the current example the information database 208 being an object-relational database provided by PostgreSQL®). The multiple fields 302 to 322 may be populated by the end-user. Based on the information provided through the fields 302 to 322, various display options and data retrieval filters, such as the tags provided in the XML code above, are enabled and form an end-user request. The XML configuration file further acts as a tool to transport the input data from the web interface 202 to the information database 208. Alternately, the XML configuration file acts as a tool to transport the input data from the user interface 300 to the information database 208. Subsequently, based on the end-user request, the portal server 104 extracts the data corresponding to the retrieval filters specified at the fields 316 to 322 from the data source specified at the field 314. The output data is extracted in a predefined format at the information database 208. Subsequently, the extracted output data is presented based on the display options specified in the XML configuration file through the output portlet 206 at the results field 324.

Each of the markups of the XML configuration file begins with a character “<” and ends with a character “>”. For example, the tag “<QuerySettings>” may be a markup. Further, the content between two similar markups is a script code corresponding to the tag. For example, a content between “<QuerySettings>” and “</QuerySettings>” may be the script code for “QuerySettings” tag. Further, the document data can include the connection information and data retrieval filters provided in the “Connection” tag, and/or the keywords or query string provided in the “QueryString” tag.

In order for a query, such as that shown in the XML sample above, to retrieve data from multiple sources, the data would need to exist in any of the data sources 210, 212 and 214 and in the information database 208 specified in the query.

The database connection details or connection information, such as that referenced in the XML code above, can be specified in the same XML configuration file or in a separate XML configuration file.

The CAT 110 in cooperation with the portal server 104 can also process the query and/or the options in the XML configuration file to detect any unnecessary data retrieval filters and assist the end-user to remove the unnecessary data retrieval filters from necessary data retrieval filters to optimize the query and reduce computational resources required to execute the query. For example, the CAT 110 may cause the processor of the portal server 104 to process the “QuerySettings” tag of the XML configuration file before data retrieval. In an embodiment, the CAT 110 may detect duplicate or overlapping data retrieval filters and assist the end-user in editing options entered through the user interface 300 to optimize the query associated with the XML configuration file. In an alternative embodiment, the CAT 110 may guide the end-user to directly edit the XML configuration file to optimize the query. In further embodiments, the CAT 110 may guide the end-user through user guide 330 field on the user interface 300.

III. Exemplary Embodiments

In an exemplary embodiment, an XML configuration file is generated at the user terminal 108 with input data embedded therein. The input data includes connection information, a set of data retrieval filters and a set of display options. As shown in FIGS. 3A and 3B, the fields 302 to 322 are populated such that user-defined options relating to data retrieval filters and display options are specified. As shown in the sample XML code above, the populated fields 302 to 322 enable generation or modification of an XML configuration file based on the input data. The CAT 110 installed on the portal server 104 facilitates the creation and storage of the XML configuration file. The XML configuration file includes document data, a markup, and a script code for manipulating data and markup.

As shown in FIG. 2, the application 112, installed on the portal server 104, stores output data retrieved from the data source 210, the data source 212 and/or the data source 214 at the information database 208. The output data may be retrieved prior to a request, containing the input data, is received at the user terminal 108. In some embodiments, the application 112 may retrieve the output data based on the XML configuration file upon receiving the input data. The retrieved output data is stored on the information database 208 in a predefined format. The predefined format includes the output data being stored in multiple tables with each row and/or column of each table being identified by a key. The keys are used to establish logical connections between rows and columns of one table with the rows and columns of another table in the information database 208. Based on the input data, the application 112 extracts the output data, corresponding to any one of the data sources 210, 212, and/or 214, from the tables of the information database 208 and displays the output data on the user interface 300 (as shown in FIGS. 3A and 3B) through the output portlet 206.

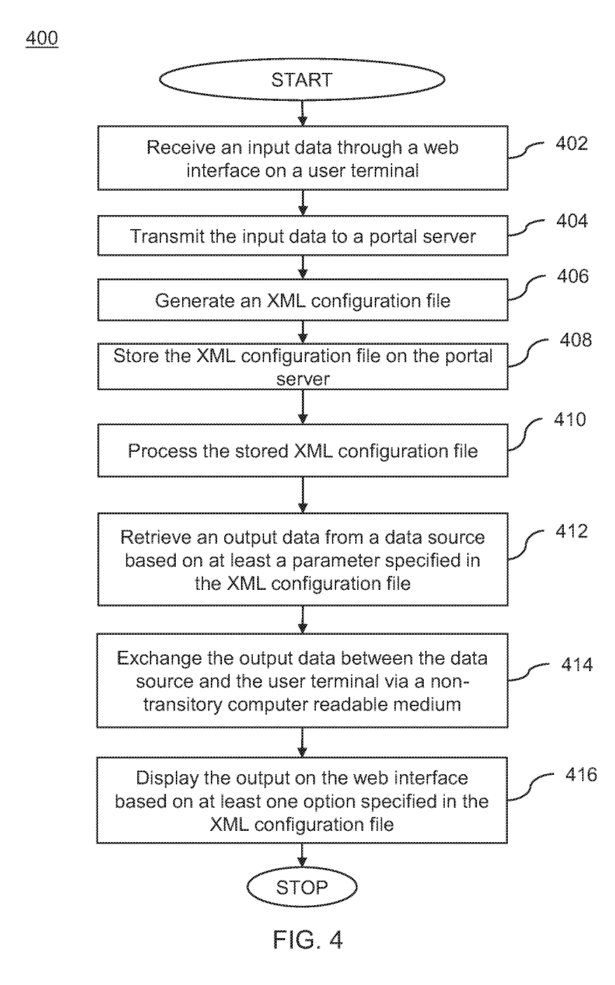

FIG. 4 illustrates a method 400 of displaying the output data on the user terminal 108 in accordance with the disclosed subject matter. This flowchart is merely provided for exemplary purposes, and embodiments are intended to include or otherwise cover any methods or procedures for data retrieval.

In accordance with the flowchart of FIG. 4, at step 402, the input data is received through the web interface 202 on the user terminal 108. The web interface 202 interacts with the input portlet 204 on the portal server 104. The web interface 202 is installed on the user terminal 108 to receive input data from an end-user in order to create or modify an XML configuration file. The input data corresponds to the end-user's desired data feeds and/or display options. The input data may include one or more identities indicative of the data source, one or more sets of keywords, and a set of display options. In some embodiments, input data is populated with information provided at the fields 302 to 320 via the user interface 300. In some embodiments, the method 400 further includes guiding an end-user to create and/or modify a query and generate a corresponding XML configuration file through the web interface 202. The user interface 300 that is part of the web interface 202 enables the end-user to formulate queries in accordance with complex query syntax requirements. Subsequently, the fields 303 to 322 may assist the end-user to generate executable optimal queries without requiring detailed knowledge of coding. The user interface 300 is displayed via the web interface 202 at the user terminal 108.

At step 404, the input data is transmitted to the portal server 104 through the input portlet 204. The input portlet 204 is communicably coupled with the CAT 110. The CAT 110 provides a web based configuration interface that facilitates the creation and storage of the XML configuration file. At step 406, the XML configuration file is generated based on the input data. The input data includes one or more identities of the data sources 102, one or more sets of keywords, and a set of display options. Further, the XML configuration file includes at least one of document data, a markup, and a script code. The document data may include a set of keywords, data retrieval filters and so forth. The markup is a sequence of characters or other symbols that are received through the web interface 202. Alternatively, the markup may be pre-configured within the XML configuration file. Further, the markup describes display options information of output data. Display options include, but are not limited to, at least one of a tabular layout, a chart layout, a news layout, a form layout, and a bullet layout. The display options can also include a font, color, location and other parameters of the displayed data. The script code is a set of expressions and statements which can be used by the portal server 104 to retrieve the output data from data source 210, 212 and/or 214. The script code can be used for executing the end-user request received at the web interface 202. The script code may include a function, procedure, method, or a block of code that may be embedded with the XML configuration file. The script code implements various functions, for example, retrieving information stored in various data sources of the system 200, performing computations, or interacting with other systems.

At step 408, the XML configuration file is stored on the portal server 104. The XML configuration file is stored in a memory local to the portal server 104. In some embodiments, the XML configuration file may be stored in a memory local to the user terminal 108 or a removable memory communicably coupled to the user terminal 108. In other embodiments, the XML configuration file may be stored on a network memory communicably coupled to the portal server 104. At step 410, the portal server 104 accesses the XML configuration file from the memory (not shown). Further, the portal server 104 processes the XML configuration file to retrieve the output data. In some embodiments, a processor (not shown), associated with the portal server 104, may process the XML configuration file to retrieve the output data from the data sources 210, 212 and/or 214.

At step 412, the portal server 104 is configured to retrieve the output data from the data sources 210, 212 and/or 214. The output data is retrieved from the data sources 210, 212 and/or 214 based on at least a parameter specified in the XML configuration file. The parameter can be, but not restricted to, a keyword specified in the input data, a data retrieval filter, a data source identity or identifier indicative of the specific data source. In some embodiments, the application 112 installed on the portal server 104 can be configured to access and process the XML configuration file to retrieve the output data. Further, the application 112 may transform the output data in accordance with a predefined format. The predefined format is a presentation format that is implemented in accordance with the display options made available through the form-based user interface 300 and subsequently the XML configuration file. Such a format facilitates data retrieval processes in a customized presentation as defined by the end-user via the web interface 202. The transformed output data is stored in the information database 208.

In some embodiments, the portal server 104 receives the output data stored in the information database 208 and displays the output data on the web interface 202 through output portlet 206. In some other embodiments, the application 112 installed and placed on the portal server 104 may receive a request based on the input data and retrieve output data from the information database 208. In an alternate embodiment, the application 112 may retrieve the output data based on input data entered by the end-user in real time through the web interface 202.

At step 414, the output data is exchanged between the data sources 210, 212 and/or 214 and the user terminal 108 via a non-transitory computer readable medium. In some embodiments, the application 112 may include the non-transitory computer readable medium. Further, the exchange of the output data is based on at least the parameter specified in the XML configuration file. At step 416, the portal server 104 displays the output data on the web interface 202 based on at least one option specified in the XML configuration file. The output data is displayed on the web interface 202 through the output portlet 206 based on the markup specified in the XML configuration file.

In some other embodiments, the user interface 300 is provided with a modify field 328. The modify field 328 is configured to allow the end-user to modify a previously stored file XML configuration file based on a modification data. The modification data is received through the web interface 202 corresponding to the XML configuration file. The modification data may include, but is not restricted to changes the end-user wants in the XML configuration file. The portal server 104 is configured to select the XML configuration file in accordance with at least one option (for example, the file name or path) specified in the modification data and modify the selected XML configuration file in accordance with the modification data.

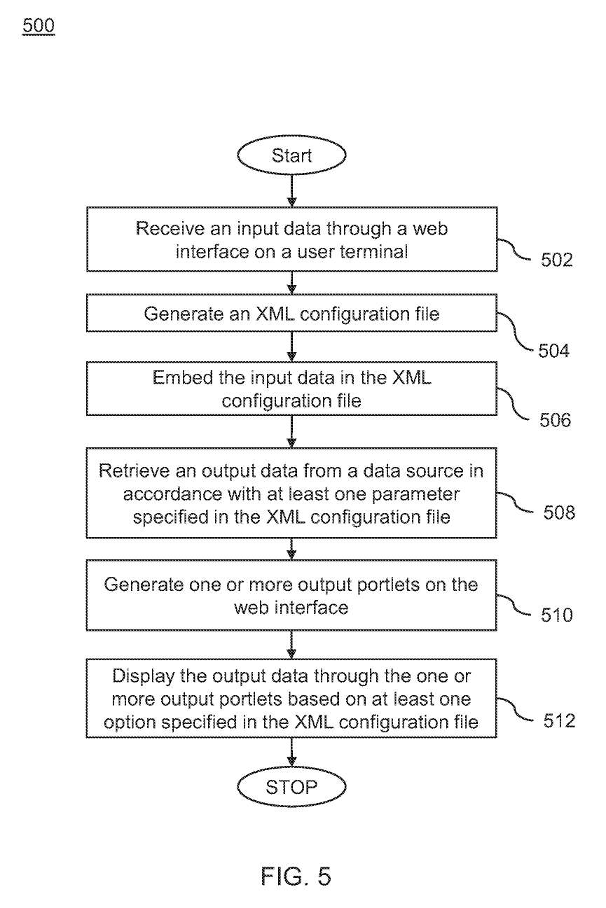

FIG. 5 is a flowchart of a method 500 for displaying an output data on a user terminal in accordance with the disclosed subject matter. At step 502, input data is received on the user terminal 108 through the web interface 202. Further, the web interface 202 is communicably coupled the portal server 104. The input data can include, one or more identities indicative of the data source, one or more sets of keywords, and a set of display options. The display options can include, but are not limited to, at least one of a tabular layout, a chart layout, a news layout, a form layout, and a bullet layout. The display options can also include a font, color, location and other parameters of the displayed data.

At step 504, an XML configuration file is generated by the portal server 104. The XML configuration file further includes document data, a markup and a script code. The markup is a sequence of characters or other symbols that are entered by the user through the web interface 202. Alternatively, the markup may be pre-configured with the XML configuration file. The markup describes display options information of output data. The script code is a set of expressions and statements which can be used by the portal server 104 to retrieve the output data from the data source 210, 212 and/or 214. The script code can be used for executing the end-user request received at the web interface 202. The script code may include a function, procedure, method, or a block of code that may be embedded with the XML configuration file. At step 506, the input data is embedded into the XML configuration file. For example, the script code may be embedded within corresponding markups and the document data can be embedded within associated script codes. At step 508, the output data is retrieved from a data source 210, 212 or 214 in accordance with at least one parameter specified in the XML configuration file. In some embodiments, the output data is transformed in accordance with the predefined format. Further the transformed output data is stored in the information database 208. The output data stored in the information database 208 is extracted for display on the web interface 202.

At step 510, the portal server 104 generates one or more output portlets on the web interface 202. At step 512, the output data is displayed through the output portlets 206 based on at least one option specified in the XML configuration file. In some embodiments, the output data is displayed on the user interface 300 at the results field 324 via the first and second output portlets 324a, 324b. In some other embodiments, the generated portlet leads to a new web page showing the output data.

In other embodiments, modification data corresponding to the XML configuration file is received through the web interface 202. Further, the XML configuration file is selected in accordance with at least one option specified in the modification data. The portal server 104 modifies the XML configuration file in accordance with the modification data.

As seen in FIG. 3, the form-based user interface 300 facilitates changes to be made to the end-user request. Changes to the end-user request include, but are not limited to, selecting a new data source, changing the retrieval filters and/or the display options. The changes can be incorporated by modifying an existing XML configuration file. Alternatively, the changes can form part of a new request and are embedded in a separate XML configuration file.

IV. Other Exemplary Embodiments

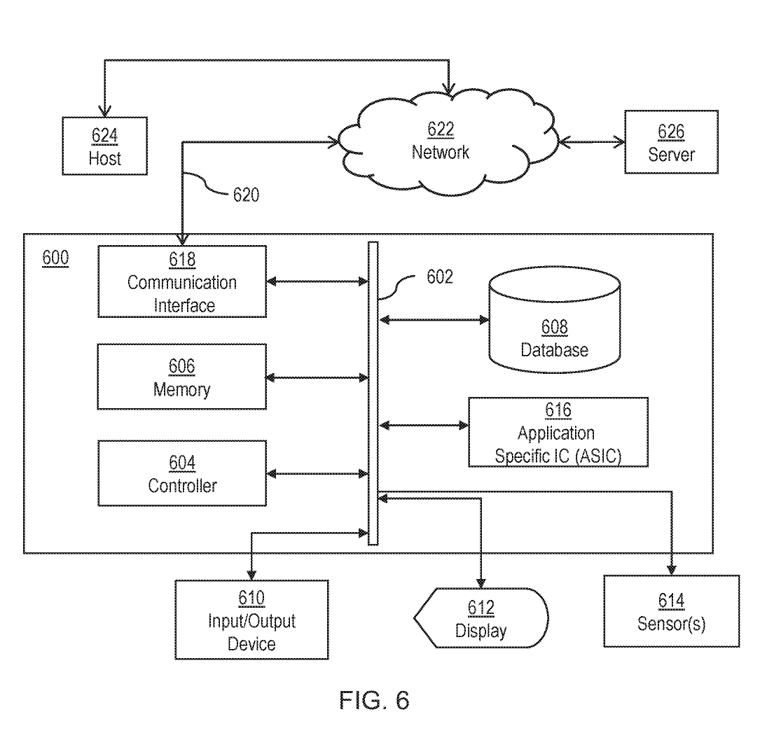

FIG. 6 illustrates a computer system 600 upon which the operation of the user terminal 108, the CAT 110, the information database 208, the portal server 104 and the application 112 may be implemented. The input portlet 204 and the output portlet 206 may also be implemented by the computer system 600. Although, the computer system 600 is depicted with respect to a particular device or equipment, it is contemplated that other devices or equipment (e.g., network elements, servers, etc.) within FIG. 6 can deploy the illustrated hardware and components of system. The computer system 600 is programmed (e.g., via computer program code or instructions) to retrieve data from the data sources 102 and to display the retrieved data on the user terminal 108 described herein and includes a communication mechanism such as a bus 602 for passing information between other internal and external components of the computer system 600. Information (also called data) is represented as a physical expression of a measurable phenomenon, typically electric voltages, but including, in other embodiments, such phenomena as magnetic, electromagnetic (light, fields, etc.), pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. The computer system 600, or a portion thereof, constitutes a means for performing one or more steps displaying an output data on the user terminal 108.

A bus 602 includes one or more parallel conductors of information so that information is transferred quickly among devices coupled to the bus 602. A processor 604 for processing information are coupled with the bus 602.

The processor 604 performs a set of operations on information as specified by an end-user. The computer program code is a set of instructions or statements providing instructions for the operation of the processor 604 and/or the computer system 600 to perform specified functions. The code, for example, may be written in a computer programming language that is compiled into a native instruction set of the processor 604. The code may also be written directly using the native instruction set (e.g., machine language). The set of operations include bringing information in from the bus 602 and placing information on the bus 602. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 604, such as a sequence of operation codes, constitute processor instructions, also called computer system instructions or, simply, computer instructions. The processor 604 may be implemented as mechanical, electrical, magnetic, optical, chemical, or quantum components, among others, alone or in combination.

The computer system 600 also includes a memory 606 coupled to the bus 602. The memory 606, such as a Random Access Memory (RAM) or any other dynamic storage device, stores information including processor instructions for storing information and instructions to be executed by the processor 604. The dynamic memory 606 allows information stored therein to be changed by the computer system 600. RAM allows a unit of information stored at a location called a memory address to be stored and retrieved independently of information at neighboring addresses. The memory 606 is also used by the processor 604 to store temporary values during execution of processor instructions. The computer system 600 also includes a Read Only Memory (ROM) or any other static storage device coupled to the bus 602 for storing static information, including instructions, that is not changed by the computer system 600. Some memory is composed of volatile storage that loses the information stored thereon when power is lost. Also coupled to the bus 602 is a non-volatile (persistent) storage device 608, such as a magnetic disk, a solid state disk, optical disk or flash card, for storing information, including instructions, that persists even when the computer system 600 is turned off or otherwise loses power.

Information, including instructions for inspecting the XML data source query files is provided to the bus 602 for use by the controller 604 from an external input/output device 610. From an input perspective, the input/output device could include one or more elements such as a keyboard containing alphanumeric keys operated by a human user, a mouse, trackball, microphone, an Infrared (IR) remote control, a joystick, a game pad, a stylus pen, a touch screen, or any other of an input/output device. These devices can be capable of controlling a position of a small cursor image presented on the display 612 and issuing commands associated with graphical elements presented on the display 612.

From an output perspective, the input/output device 610 could include a Cathode Ray Tube (CRT), a Liquid Crystal Display (LCD), a Light Emitting Diode (LED) display, an organic LED (OLED) display, an active matrix display, an Electrophoretic Display (EPD), a plasma screen, or a printer for presenting text or images. Additionally, a separate display 612 may also include any of the previously mentioned devices or any other devices capable of visually, audibly, or even by means of touch, scent, etc., to provide output data to a user. Further, the display 612 may be a touch enabled display such as capacitive or resistive screen. In some embodiments, for example, in embodiments in which the computer system 600 performs all functions automatically without human input, one or more of the external input device 610, and the display 612 may be omitted.

Sensors 614 may be provided as components of the input/output device 610, or may be provided as independent components to the system 600. The sensor(s) 614 may detect conditions in its vicinity and transform those detections into physical expressions compatible with the measurable phenomenon used to represent information in the computer system 600 such as capturing, recording and causing to store one or more still and/or moving images (e.g., videos, movies, etc.) which also may comprise audio recordings. Sensors 614 may also detect elements such as motion, temperature, imagery or video, etc.

Other external devices can also be coupled to the bus 602 such as an Application Specific IC (ASIC) device 616. In the illustrated embodiment, special purpose hardware such as the ASIC 616 might serve as special purpose hardware configured to perform operations not performed by the controller 604 quickly enough for various purposes. Examples of ASICs include graphics accelerator cards for generating images for the display 612, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 600 also includes one or more instances of a communication interface 618 coupled to the bus 602. The communication interface 618 provides a one-way or two-way communication coupling to a variety of external devices that operate with their own processors, such as printers, scanners and external disks. In general, the coupling is with a network link 620 that is connected to a local network 622 to which a variety of external devices with their own processors are connected. For example, the communication interface 618 may be a parallel port or a serial port or a Universal Serial Bus (USB) port on a personal computer. In some embodiments, the communication interface 618 is an Integrated Services Digital Network (ISDN) card, a Digital Subscriber Line (DSL) card, or a telephone modem that provides an information communication connection to a corresponding type of a telephone line. In some embodiments, the communication interface 618 is a cable modem that converts signals on the bus 602 into signals for a communication connection over a coaxial cable or into optical signals for a communication connection over a fiber optic cable. As another example, the communications interface 618 may be a Local Area Network (LAN) card to provide a data communication connection to a compatible LAN, such as Ethernet™ or an Asynchronous Transfer Mode (ATM) network. In one embodiment, wireless links may also be implemented. For wireless links, the communication interface 618 sends or receives or both sends and receives electrical, acoustic or electromagnetic signals, including infrared and optical signals that carry information streams, such as digital data. For example, in wireless handheld devices, such as mobile telephones like cell phones, the communication interface 618 includes a radio band electromagnetic transmitter and receiver called a radio transceiver. In certain embodiments, the communication interface 618 enables connection to the communication network 106 for inspecting the end-user request in the XML configuration files. Further, the communication interface 618 can include peripheral interface devices, such as a thunderbolt interface, a Personal Computer Memory Card International Association (PCMCIA) interface, etc. Although a single communication interface 618 is depicted, multiple communication interfaces can also be employed.

The term “computer-readable medium” as used herein refers to any medium that participates in providing information to the processor 604, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as the storage device 608. Volatile media include, for example, the dynamic memory 606. Transmission media include, for example, twisted pair cables, coaxial cables, copper wire, fiber optic cables, and carrier waves that travel through space without wires or cables, such as acoustic waves, optical or electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a USB flash drive, a Blu-ray disk, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 616.

The network link 620 typically provides information communication using transmission media through one or more networks to other devices that use or process the information. For example, the network link 620 may provide a connection through the local network 622 to a host computer 624 or to ISP equipment operated by an Internet Service Provider (ISP).

A computer called a server host 626, connected to the Internet, hosts a process that provides a service in response to information received over the Internet. For example, the server 626 hosts a process that provides information representing video data for presentation at the display 612. It is contemplated that the components of the computer system 600 can be deployed in various configurations within other computer systems, e.g., the host 624 and the server 626.

At least some embodiments of the invention are related to the use of the computer system 600 for implementing some or all of the techniques described herein. According to one embodiment of the invention, those techniques are performed by the computer system 600 in response to the processor 604 executing one or more sequences of one or more processor instructions contained in the memory 606. Such instructions, also called computer instructions, software and program code, may be read into the memory 606 from another computer-readable medium such as the storage device 608 or the network link 620. Execution of the sequences of instructions contained in the memory 606 causes the processor 604 to perform one or more of the method steps described herein. In alternative embodiments, hardware, such as the ASIC 616, may be used in place of or in combination with software to implement the invention. Thus, embodiments of the invention are not limited to any specific combination of hardware and software, unless otherwise explicitly stated herein.

Various forms of computer readable media may be involved in carrying one or more sequence of instructions or data or both to the processor 604 for execution. For example, instructions and data may initially be carried on a magnetic disk of a remote computer such as the host 624. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 620. An infrared detector serving as the communication interface 618 receives the instructions and data carried in the infrared signal and places information representing the instructions and data onto the bus 602. The bus 602 carries the information to the memory 606 from which the processor 604 retrieves and executes the instructions using some of the data sent with the instructions. The instructions and data received in the memory 606 may optionally be stored on the storage device 608, either before or after execution by the processor 604.

V. Alternative Embodiments

While certain embodiments of the invention are described above, and FIGS. 1 to 6 disclose the best mode for practicing the various inventive aspects, it should be understood that the invention can be embodied and configured in many different ways without departing from the spirit and scope of the invention.

For example, embodiments are disclosed above in the context of retrieving data from one or more data sources based on user queries embedded in XML configuration files. However, embodiments are intended to include or otherwise cover any type of configuration file.

Embodiments as disclosed above allow retrieval of data from different data sources and display of the data as per user-defined display options and data retrieval filters through a portal server and an application server. Embodiments of the present disclosure further enable the portal server to be a single point of access in data retrieval and display without using any additional resources or applications on a user terminal.

Embodiments are also intended to cover storing retrieved data in any predefined format in a database associated with the portal server such that the data can be displayed through portlets generated by the portal server. The predefined format can be based on a type of data source and user-defined data fields provided in the XML configuration file. Embodiments are also intended to include a user interface that assists an end-user in removing unnecessary data retrieval filters from necessary data retrieval filters. Further, the user interface is configured to guide the end-user to create queries that are familiar and optimized to a processor associated with a portal server native environment.

Embodiments are also intended to include a content authoring toolkit that provides a web based interface for facilitating the creation and storage of an XML configuration file. The content authoring toolkit is configured to assist an end-user in creation and/or modification of queries without requiring any specialized knowledge of programming or complex query syntax. Further, the content authoring toolkit does not require expertise in programming and information technology. Therefore, the content authoring toolkit provides an accessible method to a non-technical end-user for retrieving output data from multiple data source and displaying the output data based on at least one of the option specified in input data received from the end-user.

Embodiments are also intended to cover any form building toolkit that allows creation of forms without coding for a portal page. The forms can be used to receive options from an end-user and display the requested data.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary embodiments disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and

Digital Subscriber Line (xDSL)), radio, television, cable, satellite, and/or any other delivery or tunneling mechanism for carrying data. Network may include multiple networks or subnetworks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. A method for displaying output data on a user terminal, the method comprising:
receiving input data through a web interface on the user terminal, wherein the web interface interacts with an input portlet on a portal server;
transmitting, through the input portlet, the input data to a portal server;
generating an XML configuration file comprising at least one of document data, a markup, and a script code;
storing the XML configuration file on the portal server;
processing, by the portal server, the stored XML configuration file;
retrieving the output data from a data source based on at least a parameter specified in the XML configuration file;
exchanging the output data between the data source and the user terminal via a non-transitory computer readable medium, wherein the exchange of the output data is based on at least the parameter specified in the XML configuration file; and
displaying the output data on the web interface based on at least one option specified in the XML configuration file.

2. The method of claim 1, further comprising displaying the output data on one or more output portlets on the web interface.

3. The method of claim 1, wherein the input data comprises one or more identities indicative of the data source, one or more sets of keywords, and a set of display options.

4. The method of claim 3, wherein the output data is displayed in accordance with the set of display options.

5. The method of claim 1, further comprising:
receiving, through the web interface, modification data corresponding to the XML configuration file;
selecting the XML configuration file in accordance with at least one option specified in the modification data; and
modifying, by the portal server, the XML configuration file in accordance with the modification data.

6. The method of claim 1, further comprising transforming the output data in accordance with a predefined format.

7. The method of claim 6, further comprising:
storing the output data transformed to the predefined format in an information database; and
extracting the output data from the information database for display on the web interface.

8. The method of claim 1, further comprising guiding, through the web interface, an end-user to generate the XML configuration file.

9. A method of displaying output data on a user terminal, the method comprising:
receiving input data through a web interface on the user terminal, wherein the web interface is communicably coupled to a portal server;
generating, by the portal server, an XML configuration file, wherein the XML configuration file comprises document data, a markup and a script code;
embedding the input data in the XML configuration file;
retrieving the output data from a data source in accordance with at least one parameter specified in the XML configuration file;
generating, by the portal server, one or more output portlets on the web interface; and
displaying, through the one or more output portlets, the output data based on at least one option specified in the XML configuration file.

10. The method of claim 9, wherein the input data comprises one or more identities indicative of the data source, one or more sets of keywords, and a set of display options.

11. The method of claim 9, further comprising:
receiving, through the web interface, modification data corresponding to the XML configuration file;
selecting the XML configuration file in accordance with at least one option specified in the modification data; and
modifying, by the portal server, the XML configuration file in accordance with the modification data.

12. The method of claim 9, further comprising transforming the output data in accordance with a predefined format.

13. The method of claim 12, further comprising:
storing the output data transformed to the predefined format in an information database; and
extracting the output data from the information database for display on the web interface.

14. The method of claim 9, further comprising guiding, through the web interface, an end-user to generate the XML configuration file.

15. A system for displaying output data on a user terminal, the system comprising:
a web interface disposed on the user terminal, wherein the web interface is configured to receive input data through the user terminal, the input data corresponding to a data source;
a processor that is configured to generate an XML configuration file based on the input data, the XML configuration file including at least one of document data, a markup, and a script code; and
a portal server communicably coupled to the user terminal and the data source, the portal server configured to:
access the XML configuration file;
retrieve the output data from the data source in accordance with at least one parameter specified in the XML configuration file;
generate one or more output portlets on the web interface; and
display the output data on the one or more output portlets.

16. The system of claim 15, wherein the input data comprises one or more identities indicative of the data source, one or more sets of keywords, and a set of display options.

17. The system of claim 15, wherein the portal server is further configured to display the output data in accordance with the set of display options.

18. The system of claim 15, wherein the portal server is further configured to:
receive, through the web interface, modification data corresponding to the XML configuration file;
select the XML configuration file in accordance with at least one option specified in the modification data; and
modify, by the portal server, the XML configuration file in accordance with the modification data.

19. The system of claim 15, wherein the portal server is further configured to:
transform the output data in accordance with a predefined format;
store the output data transformed to the predefined format in an information database; and
extract the output data from the information database for display on the web interface.

20. The system of claim 15, wherein the portal server is further configured to generate an input portal on the web interface, wherein the input portal is configured to transmit the input data to the portal server.
